(19) United States
(12) Patent Application Publication
(10) Pub. No.: US 2013/0066768 A1
(43) Pub. Date: Mar. 14, 2013

(54) System and method for providing a web-based service for users within a social network to engage in monetary transactions via a collective investment trust

(71) Applicants: Syed Nasser, Chicago, IL (US); Aleksandr Golovin, Round Lake, IL (US)

(72) Inventors: Syed Nasser, Chicago, IL (US); Aleksandr Golovin, Round Lake, IL (US)

(21) Appl. No.: 13/228,476

(22) Filed: Sep. 9, 2011

(51) Int. Cl. G06Q 40/00; G06Q 10/00

(52) U.S. Cl. 705/39; 705/304

(57) ABSTRACT

This document proposes a system and method whereby users within a social network infrastructure can engage in monetary transactions with other users through the use of a collective investment trust. The system relies on a two-level prerequisite basis, the successful fulfillment of which deems a user of a social network a serviceable end-user. The invention links the end-users' social network(s) to an electronic transaction service. The successful conjoining of which allows said end-user to create or participate in a collective investment trust. Furthermore, a collective investment trust is not exclusively constrained to a single social network; it can be available to one or all serviceable social network(s) at the end-user's behest.

### BACKGROUND OF THE INVENTION

1. Field of the Invention

The invention relates generally to a system that allow users of a serviceable social network to engage in monetary transaction with one another through a collective investment trust.

2. Background Information

Social networking services allow its users to stay in contact with other users of the same social networking service. Such networks have made it easier for users to stay in contact with other users of the same social network by offering easier and less time-consuming ways of communicating with others users of the social network. Users can create separate social groups within the social network by inviting or accepting “friends”. Security features are incorporated in order to regulate exchange of social information at the user's behest. Furthermore, privacy controls are handled by the network infrastructure, but options are extended to users as well.

Users of a social network can create or join groups within the social network. The creator of the group can invite other users to become part of the group. A user can also become part of a group by sending an event request. When a user is invited to join a group he or she can accept or decline the event invitation. Similarly, an individual user who sends an event request can be accepted or rejected by the creator of the group. Those who become part of a group may communicate with each other through different communication methods.

Aside from social networks, online electronic transaction services and e-commerce services are widely used as a payment method for commodities and/or services. Electronic transaction services and e-commerce services provide electronic methods of payment that allow any user to transfer funds to an another compatible user in quick and efficient payments. The electronic transaction services and/or e-commerce services are also linked with a user's bank account(s) making it easy to keep track of expenditures.

Unfortunately, a system has not yet been described that allows users within a social network to engage in monetary transaction with one another. Thus, a need exists for a system and method within a social network that allows users engage in monetary transactions with one another.

### SUMMARY OF THE INVENTION

The present invention relates to a system that allows an internet user to engage in monetary transactions through the utilization of a collective investment trust within all serviceable social networks. An internet user can qualify to take part in monetary transactions within a social networking environment by fulfilling a two-level prerequisite. The prospective user must have an electronic transaction service and/or e-commerce service in addition to a serviceable social network in order to qualify for the services provided by the present invention. The invention will link the prospective user's electronic transaction service(s) and/or e-commerce service(s) with their serviceable social network(s). Upon linkage the prospective user becomes an end-user, which is to be defined as any individual who utilizes the services provided by the invention. The end-user is then able to take part in monetary transactions by electronically wiring funds between different users within a serviceable social network. This is achieved via the collective investment trust which is a managed investment fund that pools money from participants who chose to make monetary contributions toward an investment fund. Additionally, participants of a collective investment trust can electronically communicate with each other.

An end-user who creates a collective investment trust has specific administrative privileges over that investment fund. These include but are not limited to: inviting other members within a serviceable social network to become participants of a collective investment trust, establishing terms and conditions of the fund, and delegating administrative privileges to invited participants.

Furthermore, the administrator(s) of a collective investment trust can control the trust's level of accessibility within one or more serviceable social networks. Finally, security measures are put into place in order to prevent theft, misallocation of funds, or any foreseeable breach of an end-user's trust.

### BRIEF DESCRIPTION OF THE DRAWINGS

FIG. 1 shows the prerequisite process according to the present invention (FIG. 1).

FIG. 2 outlines the various roles and subsequent privileges of an end-user participating in a CIT (FIG. 2).

FIG. 3 illustrates the accessibility regulations of a CIT as handled by an administrator (FIG. 3).

FIG. 4 illustrates security measures according to the present invention (FIG. 4).

### DETAILED DESCRIPTION OF THE INVENTION

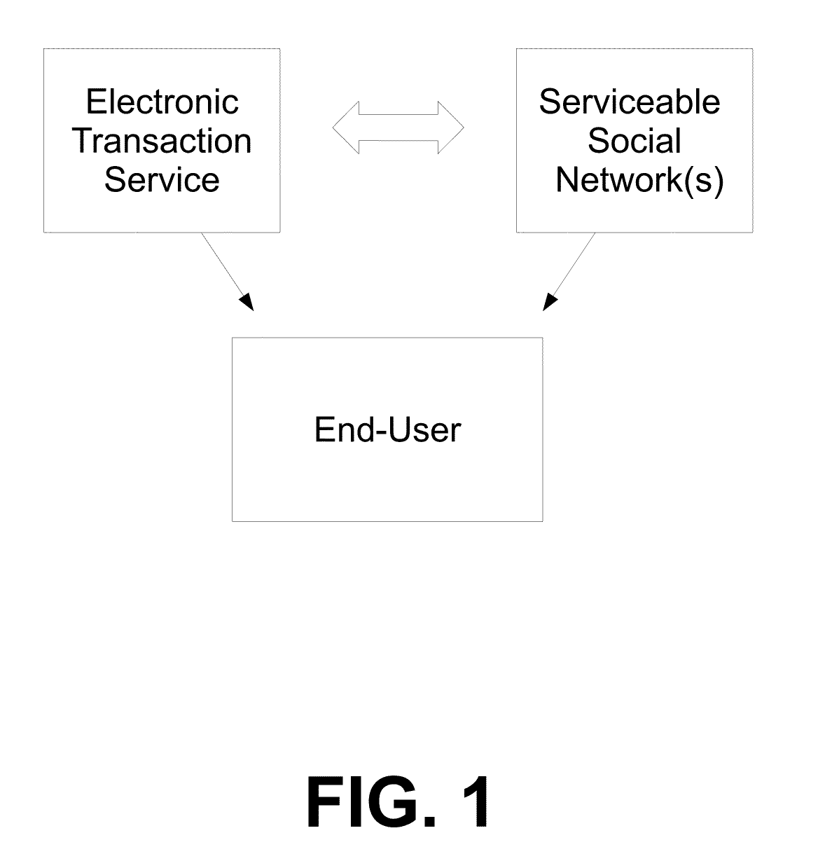

The present invention relates to a system that allows an internet user to engage in monetary transactions within all serviceable social networks through the use of a collective investment trust. The internet user qualifies to take part in monetary transactions within a social networking environment by fulfilling a two-level prerequisite. FIG. 1 illustrates the qualification process necessary to become an end-user. This includes the successful linkage of any and/or all serviceable social networks (e.g., Facebook and Myspace) with an electronic transaction service. An electronic transaction service can be provided via a credit card and/or debit card. Additionally, an e-commerce account (e.g., Paypal) can also be utilized. As used herein, “end-user” is an internet user who qualifies for the services provided by the present invention and is a user of its outlined services. An end-user is able to create or join a collective investment trust. As used herein, “collective investment trust (CIT)” refers to an investment fund created by an end-user that electronically collects funds from willing participants and deposits said funds in the account(s) of administrators who act as trustees of the CIT.

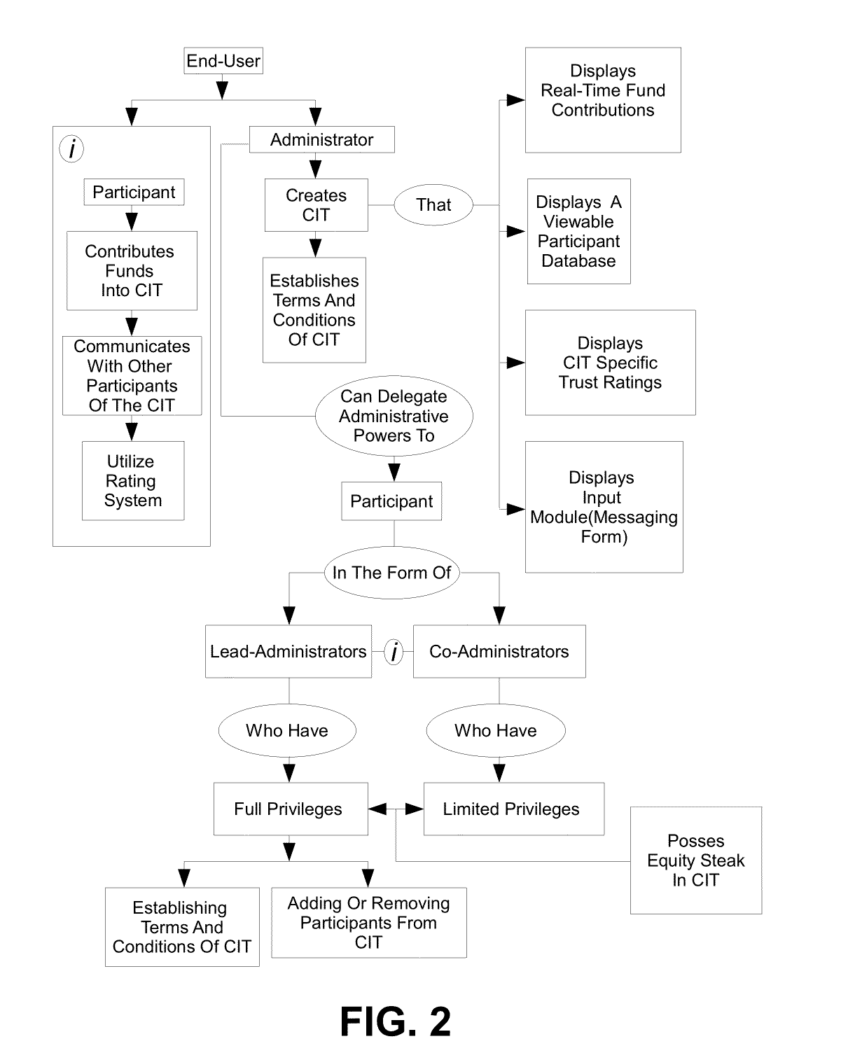

FIG. 2 displays the end-user flow chart outlining privileges set in accordance to the services provided by the present invention. An end-user assumes one of two roles within the a CIT: as a participant or an administrator. As used herein, “participant(s)” refers to an end-user who is allowed access to the CIT. The eminent privilege of a participant is the ability to contribute monetary funds to the CIT. Any participant of a CIT will also be able to communicate with fellow participants through an input module that allows participants to convey electronic messages. Additionally, a participant can utilize a rating system to convey their approval or disapproval within the CIT. As used herein an “administrator” refers to the individual(s) responsible in creating the CIT and/or establishing its terms and conditions. The administrator can occupy one of two positions: “lead administrator” or “co-administrator”. The lead administrator is usually a creator of the CIT. The lead administrator has the eminent privilege of setting the terms and conditions of the created CIT. These terms and conditions include but are not limited to: establishing contribution values, rules of fund usage, equity distribution, and accessibility. The lead administrator can also delegate administrative privileges to any participant(s) in the form of “full” or “limited” privileges. A participant with full administrative privileges takes on a lead administrator role with all the privileges of the CIT creator as outlined above. A participant with limited privileges becomes a co-administrator. The co-administrator, unlike a participant, has the added privilege of possessing a stake in the equity distribution of the fund. Any administrator, regardless of their standing, has a right to an equity stake. However, the equity distribution can only be handled by a lead administrator. The co-administrator does not possess direct authority to change the CIT terms and conditions which is exclusively handled by lead administrators as outlined above. Every administrator also has the privileges of a participant. Finally, the CIT user interface, itself, displays pertinent information such as terms and conditions, a compiled database of participants, an input module (messaging forum), CIT specific ratings (participant disapproval/approval), and real-time calculation of total fund contributions.

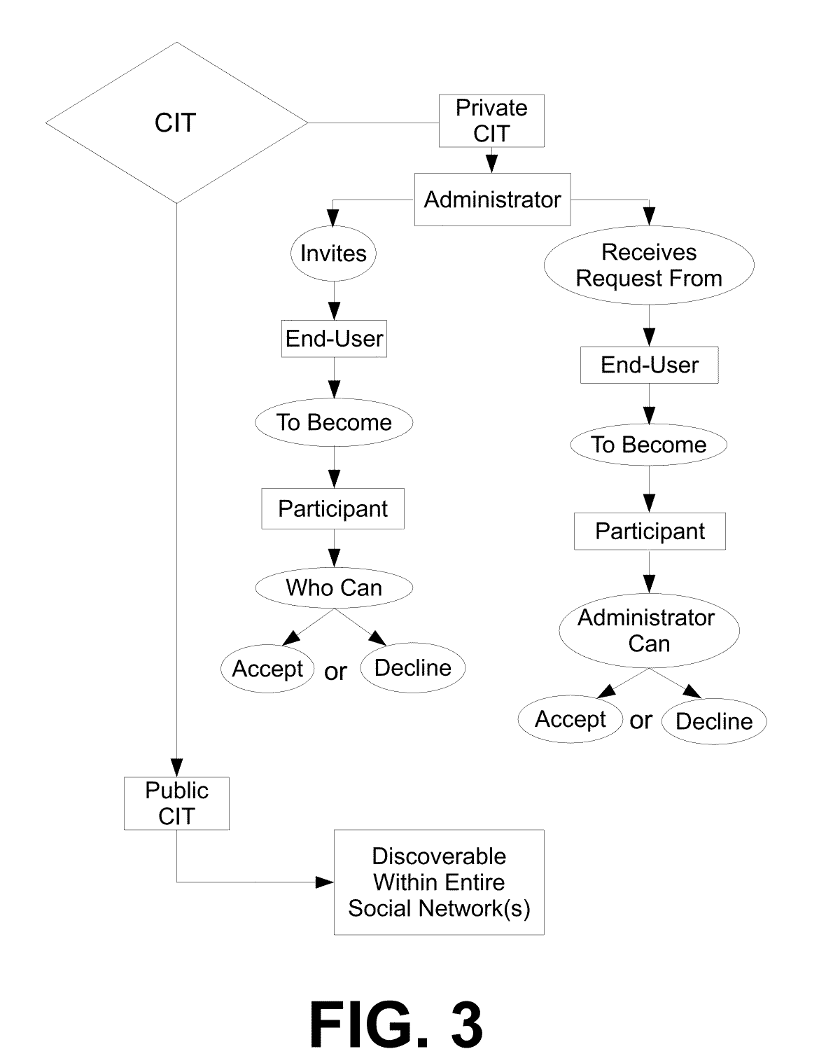

FIG. 3 outlines accessibility guidelines for an administrator established CIT. The CIT can either be “public” or “private”. A public CIT is discoverable by any end-user on any or all serviceable social networks. The lead administrator(s) can determine what serviceable social network the CIT is discoverable on. It should be noted that lead administrators can give public accessibility to any serviceable social network regardless of whether or not they, themselves, are members of that social network. A private CIT is discoverable only by the lead administrators immediate social network associates such as a “friends list”. A lead administrator can invite an end-user at his or her behest. Additionally, the lead administrator can accept or decline requests from end-users who seek to be prospective participants in the created CIT. A co-administrator cannot directly invite or receive requests from end-users to participate in a CIT.

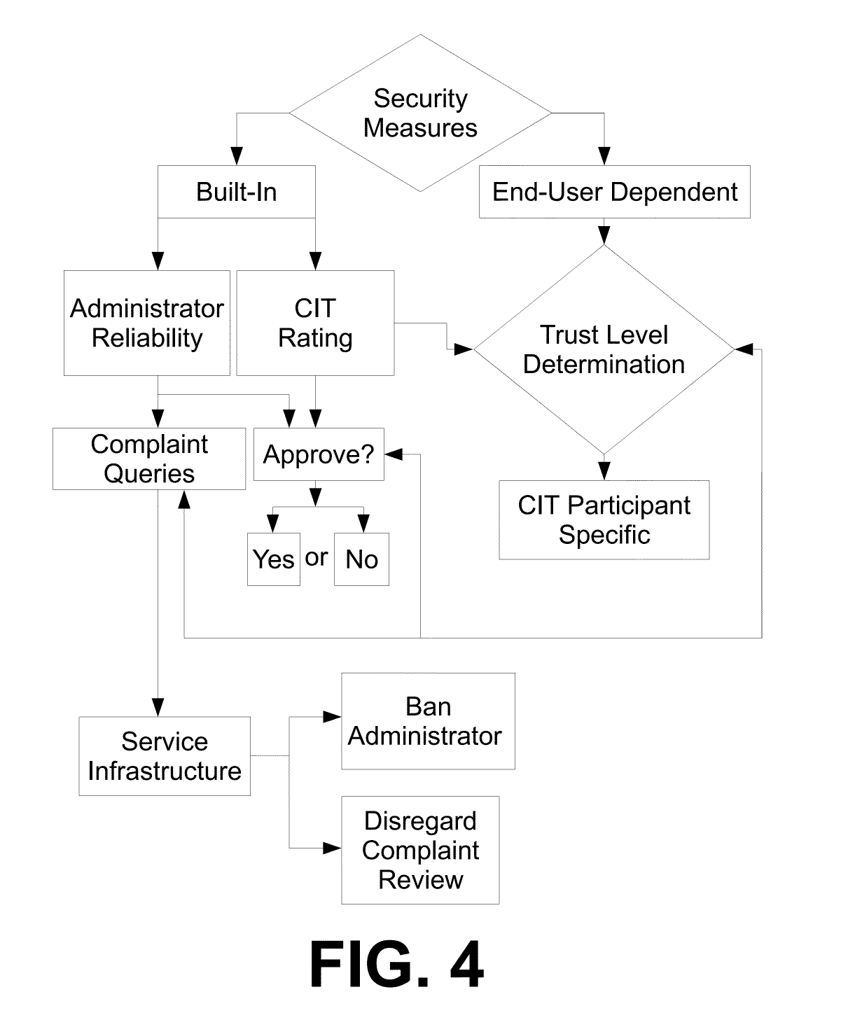

FIG. 4 illustrates the security measures within the collective investment trust according to the present invention. The security measures fall under one of two categories: “built-in” and “user dependent”. The built-in measures will be provided via the present invention's service infrastructure. These built-in measures rely on administrator reliability and CIT ratings. Administrator reliability is based on the complaint queries sent by disgruntled participants who choose to report administrators or a CIT itself. The service infrastructure will systematically review the complaint queries. Upon review, the service infrastructure can elect to ban the administrator or CIT from utilizing the services proposed by the present invention. Furthermore, the service infrastructure can also choose to disregard end-user queries if complaints of fraud, misappropriation, or other instances of malfeasance are inconsequential. Security measures are also dependent on the individual end-user. The end-user has to determine the trustworthiness of the people or entities he or she chooses to transact with. An end-user's trust level determination can be aided but not limited by the following factors: a CIT compiled participant database, administrator complaint queries, and CIT specific ratings. A viewable participant database allows the end-user to have knowledge of who partakes in a CIT. Additionally, an end-user can view information regarding whether or not an administrator or a CIT itself has been reported to the service infrastructure by other end-users prior to becoming a participant within that CIT. The end-user also has the ability to view the approval/disapproval ratings of a CIT prior to becoming a participant. The CIT ratings contribute to a track record for its administrators since end-users can view the approval/disapproval ratings of the administrators' previously created CITs. Such information is integral in creating an environment of transparency in which an end-user can invest in a CIT with confidence and security.

We claim:

1. A system and method that allows users within a social network to form collective investment trusts (CITs) which comprises of: a mechanism for linking any and/or all serviceable social networks with at least one electronic transaction service and/or e-commerce account; a user interface that allows participants to transfer funds into a collective investment trust; an administrator that is responsible in creating and handling the collective investment trust according to specific terms and conditions; a messaging forum that allows participants of a collective investment trust to electronically exchange messages through a messaging forum that is within the CIT module and; a database for storing posted information within CIT module.

2. The system of claim 1, wherein any internet user that links his or her social network(s) with at least one electronic transaction service and/or e-commerce service becomes an end-user.

3. The system of claim 1, wherein the user interface transfers participant funds into a collective investment trust is through an electronic transaction and/or e-commerce service.

4. The method of claim 1, wherein any end-user is capable of becoming a participant or administrator of a CIT.

5. The system of claim 4, wherein a CIT is first created by a single administrator.

6. The method of claim 5, wherein the initial administrator gives administrative privileges to any participant of a CIT in the form of lead administrator or co-administrator.

7. The method of claim 6, wherein the lead administrator has full administrative privileges.

8. The method of claim 6, wherein the co-administrator has limited administrative privileges.

9. The method of claim 7, wherein lead administrator can make the CIT private or open to the public.

10. The method of claim 9, wherein the administrator invites an end-user to become a participant of a private collective investment trust.

11. The method of claim 10, wherein the invited end-user accepts or rejects the invitation.

12. The method of claim 9, wherein the end-user requests to become a participant of the private collective investment trust.

13. The method of claim 12, wherein an administrator can accept or reject an end-user's request.

14. The method of claim 9, wherein any end-user can join a public collective investment trust.

15. The method of claim 7, wherein the lead administrator decides the CIT equity distribution between him or herself and the co-administrator.

16. The method of claim 1, wherein the CIT module displays applications which include information such as: the terms and conditions set forth by the administrator, the compiled database of participants, an input module (messaging forum), CIT specific ratings (participant disapproval/approval), and real-time calculation of total fund contributions.

17. The method of claim 16, wherein the input module allows a participant to view, comment, and/or delete messages within the messaging forum.

18. The method of claim 17, wherein the majority of applications within the CIT module are stored in a database for predetermined periods of time.

19. A system that allows participants to file complaint queries which are analyzed by a built-in security measures that reviews the complaint queries and decides whether to ban the administrator, ban the CIT, or disregard the complaint query.

20. The method of claim 16, wherein the CIT module gives confidence and security to participants interested in contributing funds into a CIT.
